(19) United States
(12) Patent Application Publication
(10) Pub. No.: US 2003/0041493 A1
(43) Pub. Date: Mar. 6, 2003

(54) System and method for creating a continuously changing visual image

(76) Inventor: Christopher Caiano, New Rochelle, NY (US)

Correspondence Address: Christopher Caiano, 73 Jackson St., New Rochelle, NY, 10801, US

(21) Appl. No.: 09/940,151

(22) Filed: Aug. 27, 2001

(51) Int. Cl. G09F 19/14

(52) U.S. Cl. 40/453

(57) ABSTRACT

A series of related consecutive still images are mounted along a surface. A vehicle capable of rapid movement with respect to the surface carries passengers who view the images normal to the direction of the movement of the vehicle. Such passengers traveling in the rapidly moving vehicle see consecutive still images that create a continuously changing visual image.

### BACKGROUND OF THE INVENTION

1. Field of the Invention

This invention broadly relates to a system and method for creating a continuously changing visual image.

2. State of the Art

A motion picture is perhaps the most common form of a continuously changing visual image. Motion pictures have been constantly developed and improved upon from the basic invention of the flip-book in the beginning, to high definition digital video in the present. Motion pictures are broadcast all over the world through television, even on airplanes, and streaming video is now available over the Internet.

Most of the advancements in the field of motion pictures have improved upon the quality or quantity of the picture viewed. For example, the digital video disc (DVD) has a much higher picture quality than its predecessor—the video cassette. Another example is the invention of IMAX movies. IMAX film is much larger than standard 35 mm film. When it is viewed, the size of the picture is greatly enlarged without losing quality.

These types of motion pictures have worked on the principal of moving consecutive images at a high speed in front of a still viewer.

### SUMMARY OF THE INVENTION

It is therefore the object of the invention to create a new system and method for creating a continuously changing visual image where the person viewing the image is moving and the individual images are still.

In accordance with this object, an example of the present invention is a train traveling through a tunnel with related consecutive still images mounted along the tunnel walls. As the train passes the still images at a high speed a person looking out of a side window of the train will see a continuously changing visual image.

The present invention can be applied to any vehicle that travels in a predictable range of speed and in a predetermined path. Some examples of such vehicles include trains, subways, and amusement rides such as roller coasters.

BRIEF DESCRIPTION OF THE DRAWINGS

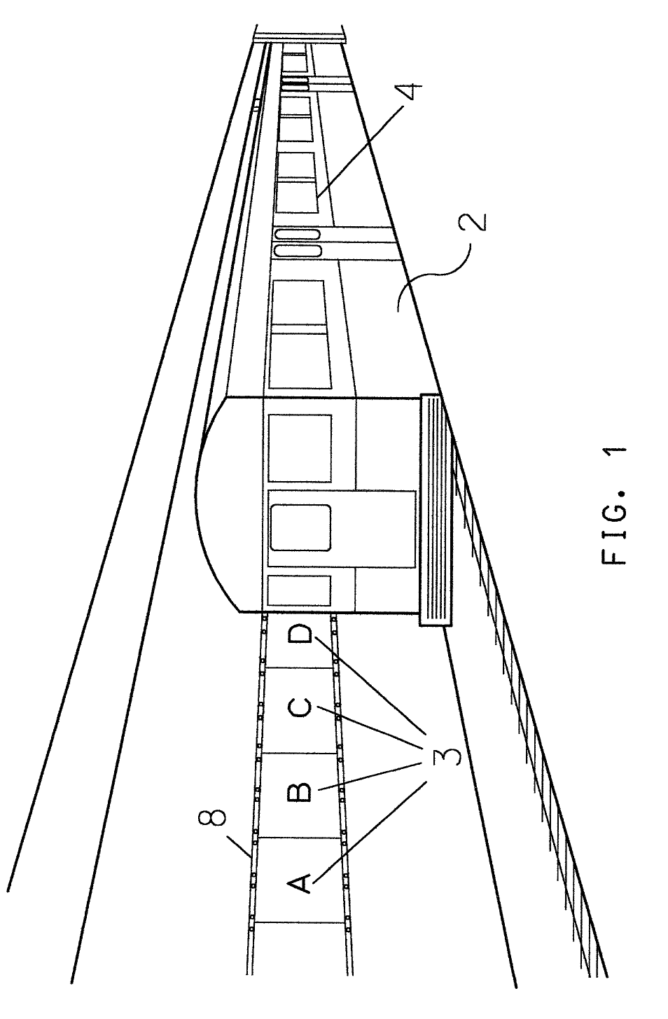

FIG. 1 is an isometric view of a train traveling through a tunnel with a series of consecutive still images shown mounted along the tunnel wall;

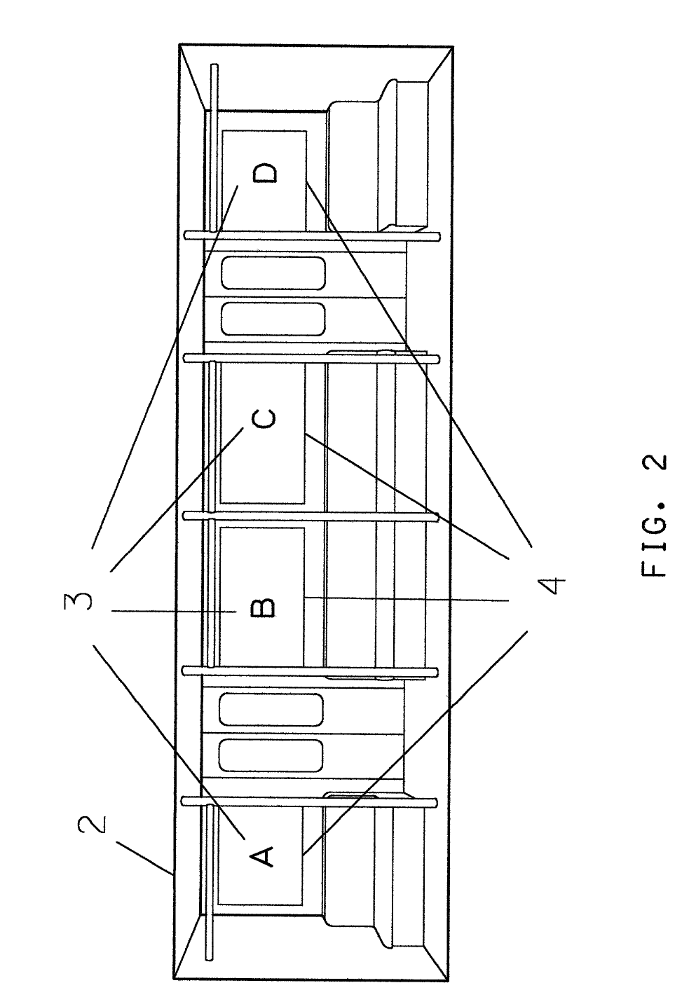

FIG. 2 is a side view of the inside of a passenger rail car with a series of consecutive still images shown in the windows; and

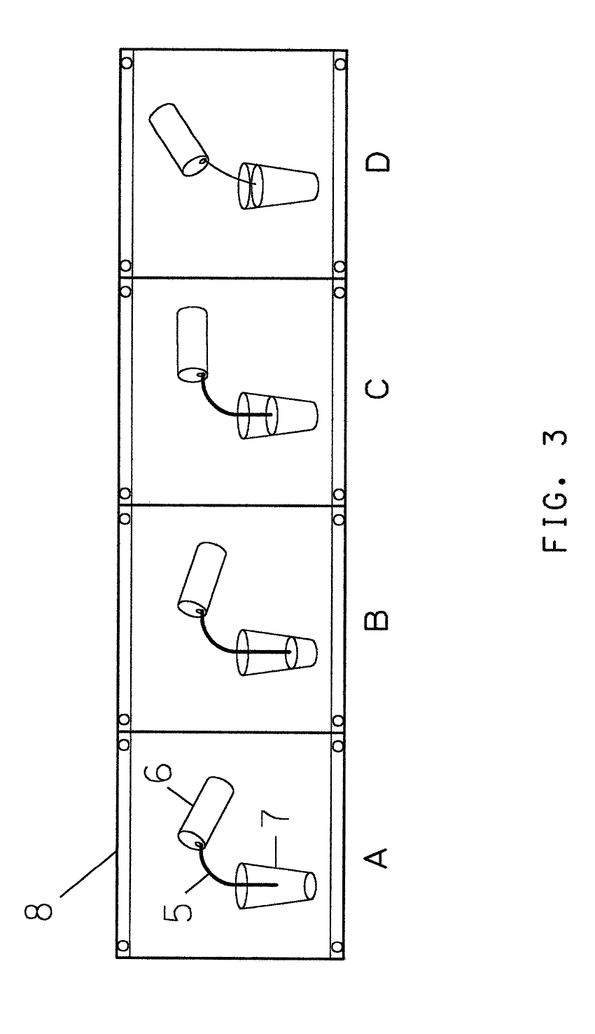

FIG. 3 is an exploded view of details A, B, C, and D in FIGS. 1 and 2. This drawing is intended to show motion and is only one example of a set of images that can be used in the present invention. Any set of images can replace the ones shown.

### DETAILED DESCRIPTION OF THE INVENTION

There is shown in FIG. 1 a train 2 traveling through a tunnel with a series of consecutive still images 3 represented by letters A, B, C, and D shown mounted along the tunnel wall. In FIG. 2 the series of consecutive still images 3 represented by letters A, B, C, and D are shown in the windows 4 of the train 2. As the train 2 passes the still images 3, as shown in FIGS. 1 and 2, a passenger of the vehicle will see a continuously changing visual image of the liquid 5 being poured from a can 6 into a glass 7 as shown in FIG. 3.

To create a continuously changing visual image, a high enough frame rate must be achieved. For the present invention the frame rate is dependent on the speed of the vehicle 2 and the size of the image frames 8 mounted on the wall. For example, if a train is traveling at a speed of 35 mph and a frame rate of 20 frames per second is desired, the length of an individual image frame must be approximately 2.5 feet.

A simple equation for determining the length of one image frame is:

$$L = \frac{1.46 S}{F}$$

Where:

L=Length of one frame in feet.

S=Speed of vehicle in miles per hour

F=Frame rate in frames per second

Once the individual frame length is determined, the height of the frame can be determined. The frame height depends on the height of the window that the images will be viewed through, the determined frame length, and the desired aspect ratio. If the height of the window is smaller than the determined frame length, then the frame length can be shortened. If this is the case, the frame rate must be recalculated. After the length and height of the individual frames are decided on, and the frame rate is known, images can be designed to fit the frames.

It may be decided that creating the images in a roll format, like a roll of film, is best for installing and removing the pictures because the images may need to be periodically replaced.

Screens capable of producing electronic images may be mounted instead of frames thus eliminating the need to periodically replace the images.

A method of lighting the images must also be considered. The images may be illuminated from light fixtures mounted on the moving vehicle, in which case the images will only be illuminated as the vehicle passes. Otherwise lights may be mounted in a fixed position near the images. These lights may be left on constantly or triggered to illuminate when a vehicle approaches.

I claim:

1. A system for creating a continuously changing visual image comprising:
a) a series of related consecutive still images appearing on a surface, and
b) a moveable vehicle capable of travel in relation to said surface whereby the related consecutive still images on said surface will appear to a viewer in said vehicle as a continuously changing visual image.

2. A system for creating a continuously changing visual image according to claim 1, wherein said vehicle is a rail car having windows therein.

3. A system for creating a continuously changing visual image according to claim 1, wherein each of such still images is a length expressed in feet equal to the product of 1.46 and the speed of said vehicle expressed in miles per hour divided by the frame rate of said continuously changing visual image expressed in frames per second.

4. A system for creating a continuously changing visual image according to claim 1, wherein said surface is a wall.

5. A wall according to claim 4, wherein said wall is the wall of a railroad tunnel.

6. A method for creating a continuously changing visual image comprising the steps of:
a) providing a series of related consecutive still images appearing on a surface, and
b) providing a moveable vehicle capable of travel in relation to said surface whereby the related consecutive still images on said surface will appear to a viewer in said vehicle as a continuously changing visual image.

7. A method for creating a continuously changing visual image according to claim 6, wherein said vehicle is a rail car having windows therein.

8. A system for creating a continuously changing visual image according to claim 6, wherein each of such still images is a length expressed in feet equal to the product of 1.46 and the speed of said vehicle expressed in miles per hour divided by the frame rate of said continuously changing visual image expressed in frames per second.

9. A system for creating a continuously changing visual image according to claim 6, wherein said surface is a wall.

10. A wall according to claim 9, wherein said wall is the wall of a railroad tunnel.
